(19) United States
(12) Patent Application Publication
(10) Pub. No.: US 2014/0203178 A1
(43) Pub. Date: Jul. 24, 2014

(54) POSITION-SENSITIVE DETECTOR FOR DETECTING PHOTON OR PARTICLE DISTRIBUTIONS

(71) Applicant: Peter Fischer, Ketsch (DE)

(72) Inventor: Peter Fischer, Ketsch (DE)

(21) Appl. No.: 14/239,800

(22) PCT Filed: Aug. 23, 2012
(86) PCT No.: PCT/EP2012/003581

§ 371 Date: Feb. 20, 2014

(30) Foreign Application Priority Data
Aug. 25, 2011 (DE) 10 2011 111 432.0

(51) Int. Cl. G01T 1/20

(52) U.S. Cl. CPC G01T 1/2018; G01T 1/2006
USPC 250/362; 250/366

(57) ABSTRACT

The present invention relates to a position-sensitive detector for detecting photon or particle distributions, in which the detector receiving surface (1) is formed by several detector cells (2) comprised of individual detector elements, which are connected with several readout channels (5). The allocation of detector cells (2) to the readout channels (5) is selected in such a way that the center of gravity position of the photon or particle distribution impinging on the detector receiving surface (1) can be locally determined from signals of the readout channels (5). The detector enables a high spatial resolution given a low number of readout channels.

### TECHNICAL AREA OF APPLICATION

The present invention relates to a position-sensitive detector for detecting photon or particle distributions, with a detector receiving surface formed by a plurality of detector cells comprised of individual detector elements, and a number N of readout channels for the detector cells, which is lower than the number of detector cells, wherein each detector cell is allocated to at least one of the readout channels and connected therewith.

For example, position-sensitive photodetectors are used for detecting gamma quanta in positron emission tomography (PET). The gamma quanta to be detected are here absorbed in scintillation crystals, which interact with the gamma quanta to generate several thousand optical photons. This light must be detected with a spatial resolution of 0.5 to 3 mm. In light of their high thickness of several cm required for absorbing the gamma quanta, the scintillation crystals are usually distributed in columns with a width of 0.5 to 3 mm, so as to obtain the needed spatial resolution. The photons emitted by the individual columns must then be detected with a photodetector that also reaches this spatial resolution. However, configuring the photodetector with a high number of channels corresponding to the number of columns is complicated and costly. One way to reduce costs involves distributing the light exiting the scintillation crystals to several larger detector elements via an optical coupling (“light spreader”), the signals of which are then used to interpolate the respective location at which the light exited. However, this leads to edge effects, and greatly limits the possible mechanical structure.

DE 102005055656 B3 describes a device for processing detector signals that comprises fewer readout channels than detector elements. In this device, each detector is connected with each readout channel. The position of incident photons is here determined by suitably weighting the detector signals with a binary code.

US 2011/0001053 A1 discloses a detection device formed by several detector cells, in which individual channels are combined into signal processing units for the detector signals. However, this does not reduce the number of readout channels connecting the detector cells with the signal processing units.

The object of the present invention is to provide a position-sensitive detector for detecting photon or particle distributions, which achieves a high spatial resolution with a low number of readout channels. A detector configured as a photodetector is also to be suitable for use in a gamma detector.

### WAYS FOR IMPLEMENTING THE INVENTION

The object is achieved with the position-sensitive detector according to claim 1. Advantageous embodiments of the detector are the subject of the dependent claims, or may be derived from the following specification along with the exemplary embodiment.

The proposed detector comprises a detector receiving surface formed by several detector cells consisting of individual detector elements. As a consequence, the detector receiving surface is segmented into the individual detector cells, which can be read out via readout channels of the detector. To this end, the detector comprises a number N of readout channels for the detector cells, which is much lower than the number of detector cells. The detector preferably comprises a number of N=3 or N=4 evaluation channels. The number of detector cells preferably measures at least 30×30 detector cells. Each detector cell used for detection is here allocated to at least one of the readout channels, preferably each to precisely one readout channel, and connected with the latter. In the proposed detector, the allocation of readout channels to the detector cells is selected in such a way that the center of gravity position of the photon or particle distribution impinging on the detector receiving surface can be determined from signals of the readout channels. This allocation is preferably selected in such a way that this position can be calculated from the readout channel signals via center of gravity calculation. In a preferred embodiment, the detector is designed as a photodetector with photodiodes as detector elements.

The allocation of detector cells to the readout channels is here preferably respectively locally approximated to a distribution function, which in an ideal case where the receiving surface has not been discretized by detector cells having a finite size would at each point make it possible to clearly determine the position of an individually impinging photon or particle.

Each readout channel here has allocated to it a position around the detector receiving surface or on the detector receiving surface, wherein these N positions span a surface in which lies the detector receiving surface. The allocation of detector cells to the readout channels is then respectively locally approximated to the selected distribution function. The distribution function preferably allocates signal portions of the detector cells to each readout channel as a linear or nonlinear function of the position of the respective detector cell relative to the position allocated to the respective readout channel. The approximation takes place by examining regions that encompass several detector cells. In these regions, the allocation of individual detector cells to the readout channels is then selected in such a way as to yield approximately a distribution of signal portions on the readout channels over the respectively examined region of the kind obtained by the distribution function for a detector cell arranged in the center of gravity point of the region.

In an embodiment of the detector in which the individual detector cells comprise approximately rectangular receiving surfaces and form a rectangular arrangement with perpendicular rows and columns, use is preferably made of N=4 readout channels in all, which correspond with the corners of the rectangular arrangement. While only N=3 readout channels can also be used in a rectangular arrangement, the use of four readout channels leads to a lower noise component. However, using a total of N=3 readout channels is advantageous, for example, for a triangular arrangement of detector cells.

In the proposed photodetector, the individual detector cells can be avalanche photodiodes. The entire photodetector is preferably designed as a silicon photomultiplier, which exhibits a high amplification for the impinging photon distributions. For example, in the case of a detector for detecting particle distributions, the detector cells can be MAPS (monolithic active pixel sensors).

In another advantageous embodiment, a scintillator comprised of several scintillation crystals is arranged over the detector receiving surface for detecting X-ray or gamma quanta, converting the impinging X-ray or gamma quanta into optical photons that can be detected with photodiodes as the detector elements. For example, the scintillator can here be divided into individual columns, as known from prior art to achieve a high spatial resolution.

When configured as a photodetector, the proposed detector can be used in a gamma detector in conjunction with scintillation crystals, for example. Exemplary embodiments for the latter include the already mentioned PET as well as applications in material sciences. Such a photodetector can also be used in the field of research for applications that require the high spatial resolution with the fewest possible electronic readout channels.

### BRIEF DESCRIPTION OF THE DRAWINGS

The proposed detector will be briefly described once again below based on an exemplary embodiment in conjunction with the drawings. Shown on:

FIG. 1 are two examples for allocating the individual detector cells of the proposed detector to four readout channels in all;

FIG. 2 are four partial images depicting another example for allocating the individual detector cells of the proposed detector to the four readout channels;

FIG. 3 is an example for a simulation (“flood map”) given an inclined arrangement of a scintillator in conjunction with the proposed detector; and

FIG. 4 is a highly schematized top view of a possible configuration of the proposed detector, in section; and

FIG. 5 is a schematic view of an arrangement comprised of several adjacent detectors.

In the following example, the detector is designed as a silicon photomultiplier (SiPM), in which the detector receiving surface is composed of numerous individual cells, referred to in the present patent application as detector cells. The detector cells in turn consist in a known manner of avalanche photodiodes with a series resistor. In the proposed photodetector, the detector cells are not all connected to one electrode or one readout or output channel, but rather distributed among several readout channels. In the present example for a rectangular detector receiving surface, N=4 readout channels were used. The allocation of detector cells to the readout channels is selected in such a way that the center of gravity position of the photon distribution impinging on the detector surface can be determined from the signals of the readout channels via center of gravity calculation. The photons impinging on a region of detector cells yield signals at the N outputs each corresponding to the number of cells in the region impinged by the photons that are connected to the respective readout channel. These signals can then be used to count back to the position of the region based on the cell allocation via center of gravity calculation. The allocation of cells to the readout or output channels here takes place in such a way as to achieve it locally as effectively as possible, within the discretization accuracy stemming from the finite size of the individual cells.

Center of gravity calculation is here only one preferred example based on a special distribution function. For purposes of center of gravity calculation, the selected positions or coordinates {x_{channel,i}, y_{channel,i}} to which the readout channels i (i=1 . . . N) were allocated are weighted and added with the signals (signalᵢ) measured there. This is all standardized to the overall signal:

{x_{rec},y_{rec}}=sum[{x_{channel,i},y_{channel,i}}*signalᵢ]/sum[signalᵢ]

wherein {x_{rec}, y_{rec}} corresponds to the coordinate of the position to be determined.

Other distribution functions that are nonlinear over the receiving surface can also be selected, for example if a higher spatial resolution is desired in the center of the receiving surface than on the edges. The allocation takes place as a function of the selected distribution function, wherein this distribution function is then respectively locally approximated as well as possible by the allocation. Selecting a distribution function shaped like a sinh (hyperbolic sine) in directions parallel to the edges of the detector receiving surface advantageously yields a position error that is identical over the entire receiving surface, and a higher average spatial resolution by comparison to a distribution function for center of gravity calculation (at a set noise level).

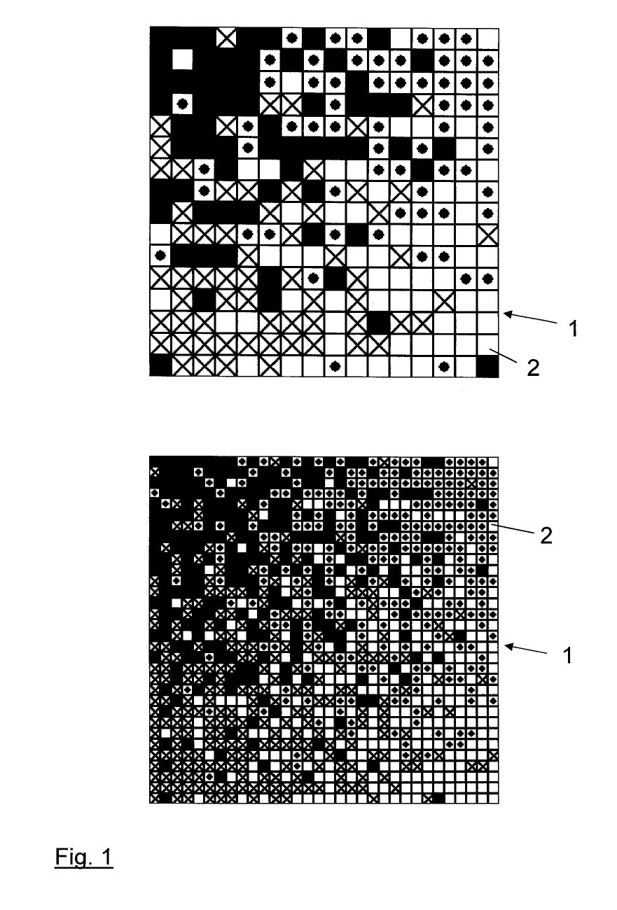

FIG. 1 presents two examples relating to the above for allocating the detector cells 2 of a detector receiving surface 1 to the four readout channels for two different discretizations. For purposes of illustration, the receiving surface consists only of 16×16 detector cells 2 in the top part of the figure, and 32×32 detector cells 2 in the bottom part of the figure. In photodetectors used in practice, the number of cells can again be higher, for example ranging between 40×40 and 160×160 cells or more. The varying allocation of individual detector cells 2 to the four readout channels is denoted by the differing representation of the cells. Such an allocation of detector cells 2 to the four readout channels approximates a distribution function with which the center of gravity position for the impinging photon distribution can be determined from the signals of the four readout channels via center of gravity calculation. This leads to a nearly identical spatial resolution over the entire receiving surface, wherein the determination error for each region of the detector receiving surface 1 is also approximately the same.

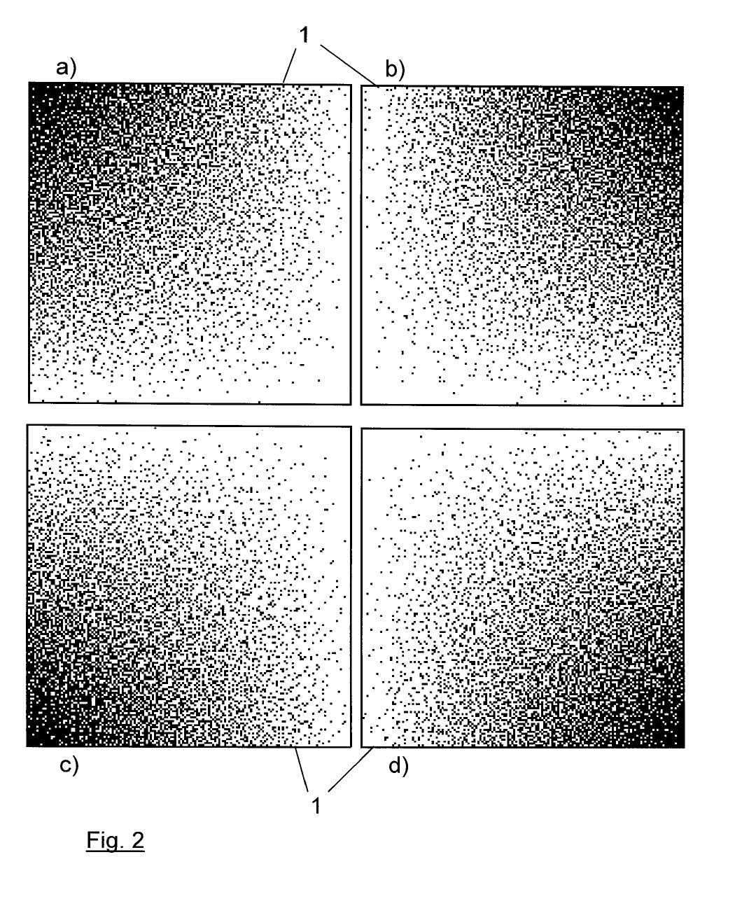

In four partial images a to d, FIG. 2 shows the respective allocation of detector cells 2 to one of the readout channels for a detector receiving surface 1 having a size of 80×80 cells. The points in the respective partial images mark the cells that are allocated to the respective channel. Each cell here has allocated to it precisely one channel, so that any overlap between the four partial images would yield a completely black surface.

Described below is an example of an approach toward allocating the detector cells to the readout channels, with which the allocations on FIGS. 1 and 2 were generated. The following steps were here performed:

1) In a first step, the ideal percentage distribution Iᵢ of a (unit) signal to the N readout channels is calculated for each detector cell (pixel) (i=1 . . . N). To this end, the selected distribution function is integrated over the surface of the cell. In this example, the sum of the N portions yields the value 1 due to the unit signal.
2) The individual detector cells are initially not allocated to any channel.
3) A size of 2×2 detector cells is set as the starting block or cluster size M×M.
4) The process begins with a cluster in a corner of the detector receiving surface.
5) The sum of the M×M distribution portions Iᵢ is calculated for this cluster. As a rule, Iᵢ is not an integer. An already completed allocation of pixels in the cluster to a readout channel is added together in Fᵢ. Fᵢ is an integer for all i=1 . . . N.
6) As long as some Iᵢ exceeds the accompanying Fᵢ by more than 1, another pixel in the cluster must be allocated to the channel i:
An as yet unallocated pixel in the cluster is randomly selected and allocated to the channel i;
Fᵢ is increased by 1.

This step is repeated until all differences Iᵢ-Fᵢ are less than 1.

7) The cluster is shifted by N to the right/left or up/down, and the process is repeated starting with 5) until the entire detector receiving surface has been run through. Of course, another location on the receiving surface can here basically serve as the starting point, or the entire surface can be run through based on another pattern.
8) In the next step, the cluster size is increased, preferably doubled, wherein the maximum size is limited by the size of the detector receiving surface, and the process is restarted at step 4). This takes place until all detector cells or pixels have been allocated to a readout channel.

The more individual detector cells are available on the detector receiving surface, the better the approximation to the desired distribution function. This also holds true with respect to subsequent error in position determination, which also tapers with an increasing size of the respectively illuminated regions, since statistics then improve. Roughly 10 blocks with an edge length of 0.8 mm can be differentiated given a detector with an edge length of 8 mm and cells measuring 50 μm×50 μm (square).

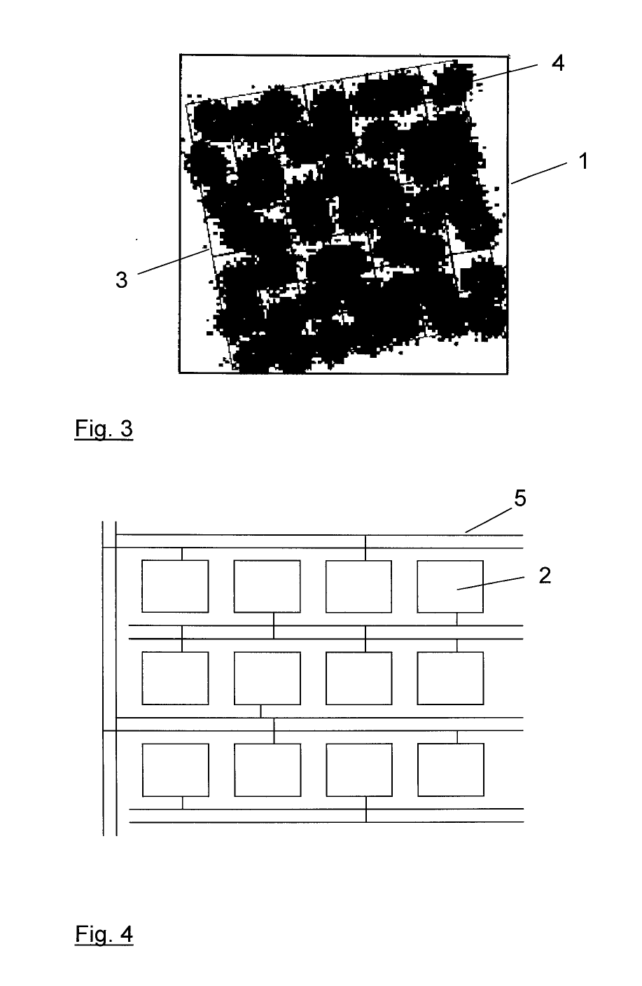

One special advantage to the proposed photodetector lies in the fact that the spatial resolution and determination accuracy do not depend on the position of a scintillator over the receiving surface. In this regard, FIG. 3 presents an example for a scintillator 3 that is twisted relative to the edges of the detector receiving surface 1 and has 7×7 individual scintillator crystals. The photons emitted by the crystals were here simulated with a finite number of photons, and the allocation of detector cells to the readout channels described above was assumed. A detector receiving surface with 100×100 cells was here simulated. As evident from the impinging sites 4 of this so-called flood map calculated via the allocation, the positions of the individual scintillator crystals can be effectively resolved, despite the twisting. As a consequence, the photodetector is very tolerant to a maladjustment of a scintillator possibly used in conjunction with the detector.

FIG. 4 presents yet another highly schematized example for a structural design of the photodetector in a top view, wherein only a section with 4×3 detector cells can be discerned. The receiving surfaces of the individual detector cells 2 are rectangular in design, and arranged in rows and columns perpendicular to each other. Two respective readout channels 5 run between the individual rows, so that each detector cell 2 lies between four readout channels 5. The readout channels themselves run along the edge of the detector receiving surface in the direction of the columns. The figure schematically denotes the connection between the individual detector cells 2 and the respective readout channels 5. This connection can also be established underneath the detector cells.

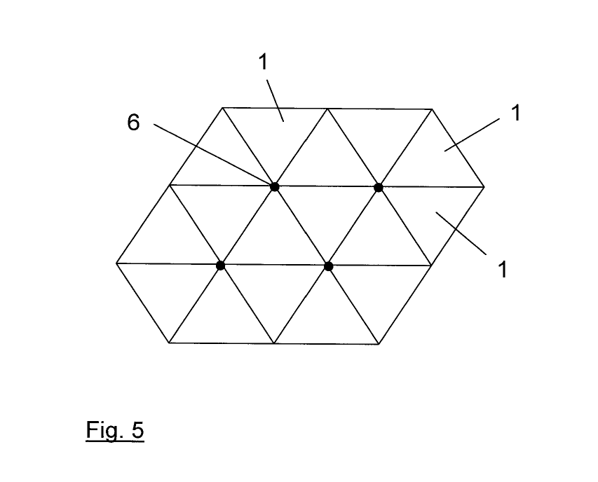

FIG. 5 provides an exemplary view of an arrangement comprised of several adjacent detectors with a triangular detector receiving surface 1. Each of these detectors comprises three readout channels, which are allocated to the corners of the detector receiving surfaces 1. In an advantageous embodiment, respective one or more readout channels of respectively adjacent detectors are connected with each other, i.e., are used together. In the example on FIG. 5, the respective readout channel allocated to the corner point 6 can be used by all six adjacent detectors together. The same holds true for the respective other corner points. As a consequence, the number of readout channels can be reduced further given such an arrangement.

### REFERENCE LIST

1 Detector receiving surface
2 Detector cells or pixels
3 Scintillator
4 Simulated impinging sites
5 Readout channels
6 Corner point

What is claimed is:

1. A position-sensitive detector for detecting photon or particle distributions, with
a detector receiving surface formed by several detector cells comprised of individual detector elements, and
a number N of readout channels for the detector cells, which is lower than the number of detector cells,
wherein each detector cell used for detection is allocated to at least one of the readout channels and connected therewith, and
the allocation of detector cells to the readout channels is selected in such a way that the center of gravity position of the photon or particle distribution impinging on the detector receiving surface can be determined from signals of the readout channels.

2. The detector according to claim 1,
characterized in that
the allocation of detector cells to the readout channels is respectively locally approximated to a distribution function, which in an ideal case where the receiving surface has not been discretized by detector cells having a finite size would at each point make it possible to uniquely determine the position of an individually impinging photon or particle.

3. The detector according to claim 1,
characterized in that
each readout channel has allocated to it a position around the detector receiving surface or on the detector receiving surface, wherein the positions span a surface in which lies the detector receiving surface, and that
the allocation of detector cells to the readout channels is respectively locally approximated to a distribution function, which allocates signal portions of the detector cells to each readout channel as a linear or nonlinear function of a position of the respective detector cell relative to the position allocated to the respective readout channel.

4. The detector according to claim 3,
characterized in that
the positions allocated to the readout channels are corner points of the detector receiving surface.

5. The detector according to claim 1,
characterized in that
the allocation of detector cells to the readout channels is selected in such a way that the center of gravity position of the photon or particle distribution impinging on the detector receiving surface can be determined from the signals of the readout channels via center of gravity calculation.

6. The detector according to claim 1,
characterized in that
each detector cell used for detection has allocated to it only one respective readout channel, and is connected with the latter.

7. The detector according to claim 1,
characterized in that
the detector cells comprise rectangular receiving surfaces, and form a rectangular arrangement with rows and columns orthogonal to each other, wherein the detector comprises four readout channels in all.

8. The detector according to claim 7,
characterized in that
the allocation of detector cells to the readout channels is respectively locally approximated to a distribution function shaped like a hyperbolic sine in directions parallel to edges of the detector receiving surface.

9. The detector according to claim 1,
characterized in that
the detector cells form a triangular arrangement, wherein the detector comprises three readout channels in all.

10. The detector according to claim 1,
characterized in that
the detector cells are formed by avalanche photodiodes.

11. The detector according to claim 1,
characterized in that
the detector is designed as a silicon photomultiplier.

12. The detector according to claim 1,
characterized in that
one or more scintillation crystals are arranged over the detector receiving surface, converting impinging X-ray or gamma quanta into optical photons to which the detector elements are sensitive.

13. An arrangement comprised of several adjacent detectors according to claim 1, in which one or more readout channels of respectively adjacent detectors are connected with each other.

14. Use of a detector or the arrangement according to claim 13 as a photodetector in a detector for positron-emission tomography.

15. Use of a detector or the arrangement according to claim 1 as a photodetector in a detector for positron-emission tomography.

16. An arrangement comprised of several adjacent detectors according to claim 2, in which one or more readout channels of respectively adjacent detectors are connected with each other.

17. An arrangement comprised of several adjacent detectors according to claim 3, in which one or more readout channels of respectively adjacent detectors are connected with each other.

18. An arrangement comprised of several adjacent detectors according to claim 4, in which one or more readout channels of respectively adjacent detectors are connected with each other.

19. An arrangement comprised of several adjacent detectors according to claim 5, in which one or more readout channels of respectively adjacent detectors are connected with each other.
